(19) United States
(12) Patent Application Publication
(10) Pub. No.: US 2016/0371066 A1
(43) Pub. Date: Dec. 22, 2016

(54) COMPUTER THAT PERFORMS COMPILING, COMPILING METHOD AND STORAGE MEDIUM THAT STORES COMPILER PROGRAM

(71) Applicant: FUJITSU LIMITED, Kawasaki-shi (JP)

(72) Inventor: Masahiro ARAKAWA, Fuji (JP)

(73) Assignee: FUJITSU LIMITED, Kawasaki-shi (JP)

(21) Appl. No.: 15/164,298

(22) Filed: May 25, 2016

(30) Foreign Application Priority Data
Jun. 17, 2015 (JP) 2015-122279

(51) Int. Cl. G06F 9/45

(52) U.S. Cl. CPC G06F 8/41

(57) ABSTRACT

A computer that performs compiling, including a processor configured to execute a process including adding the number of access times to each of a plurality of data items included in an object specified in a source program counted based on the source program to the number of access times to each of one or more data items included in each of the plurality of data items based on the source program, and determining an order of each of the plurality of data items when compiling the source program and arranging the compiled program in a storage region based on the number of access times to each data resulting from the addition.

### CROSS-REFERENCE TO RELATED APPLICATION

This application is based upon and claims the benefit of priority of the prior Japanese Patent Application No. 2015-122279, filed on Jun. 17, 2015, the entire contents of which are incorporated herein by reference.

### FIELD

The embodiment discussed herein is related to a computer that performs compiling, a compiling method, and a storage medium that stores a compiler program.

### BACKGROUND

In the related art, there is a technology to compile a source program and generate a computer-executable program. In addition, there is a technology in which a part of data of a program is stored in a cache memory in order to improve an access performance of the program. As the related technology, for example, there is a technology in which an instruction for a memory access is analyzed from an input program analysis result, and an arrangement in a class elements array is changed based on access patterns including the arrangement in the class element array, the number of access times, and an order of accesses. Japanese Laid-open Patent Publication No. 2010-003031 is an example of related art.

However, according to the related art, if there is a nested class in which other data is included in any of the data items included in an object specified in a source program, it is difficult to improve the access performance of the program obtainable by compiling the source program. Specifically, for example, from the source program, even if the number of times the data outside the nested class is written is construed as the number of access times of the data outside the nested class, there is a problem in that it may not be the exact number of access times. Then, even if the arrangement of the data items is changed according to the inaccurate number of access times, the access performance of the program is not improved. In addition, if the arrangement of the data items having a large number of access times is changed while ignoring the nested class, there is a problem in that the program may not operate correctly.

According to an aspect of the disclosure, the present disclosure has an object to provide a computer that performs compiling, a compiling method, and a compiler program that can improve the access performance of a program which is the program compiled from a source program.

### SUMMARY

According to an aspect of the invention, a computer that performs compiling includes a processor configured to execute a process including adding the number of access times to each of a plurality of data items included in an object specified in a source program counted based on the source program to the number of access times to each of one or more data items included in each of the plurality of data items based on the source program, and determining an order of each of the plurality of data items when compiling the source program and arranging the compiled program in a storage region based on the number of access times to each data resulting from the addition.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A to FIG. 1C are explanatory diagrams illustrating an operation example of a computer;

FIG. 2 is an explanatory diagram illustrating a hardware configuration example of the computer;

FIG. 3 is an explanatory diagram illustrating a functional configuration example of the computer;

FIG. 4 is an explanatory diagram illustrating an example of a source program written in a C++ language;

FIG. 5 is an explanatory diagram illustrating an example of type information of intermediate language 1 information before source tuning;

FIG. 6 is an explanatory diagram illustrating an example of a data structure before the source tuning;

FIG. 7 is an explanatory diagram illustrating an example of expression information of intermediate language 1 information before the source tuning;

FIG. 8 is a flowchart illustrating an example of a compiling processing procedure;

FIG. 9 is an explanatory diagram illustrating an example of stored content of tuning information;

FIG. 10 is a flowchart (part 1) illustrating an example of a number of access times collection processing procedure;

FIG. 11 is a flowchart (part 2) illustrating an example of a number of access times collection processing procedure;

FIG. 12 is a flowchart (part 3) illustrating an example of a number of access times collection processing procedure;

FIG. 13 is a flowchart illustrating an example of a partial object number of access times update processing procedure;

FIG. 14 is a flowchart (part 1) illustrating an example of a member information arrangement position determination processing procedure;

FIG. 15 is a flowchart (part 2) illustrating an example of a member information arrangement position determination processing procedure;

FIG. 16 is a flowchart (part 1) illustrating an example of a member information arrangement position reflection processing procedure;

FIG. 17 is a flowchart (part 2) illustrating an example of a member information arrangement position reflection processing procedure;

FIG. 18 is an explanatory diagram illustrating an example of type information of intermediate language 1 information after the source tuning;

FIG. 19 is an explanatory diagram illustrating an example of a data structure after the source tuning; and

FIG. 20A and FIG. 20B are explanatory diagrams illustrating a result of a change of the data structure.

### DESCRIPTION OF EMBODIMENT

Hereinafter, an embodiment of a disclosed computer that performs compiling, a compiling method, and a compiler program will be described in detail with reference to the drawings.

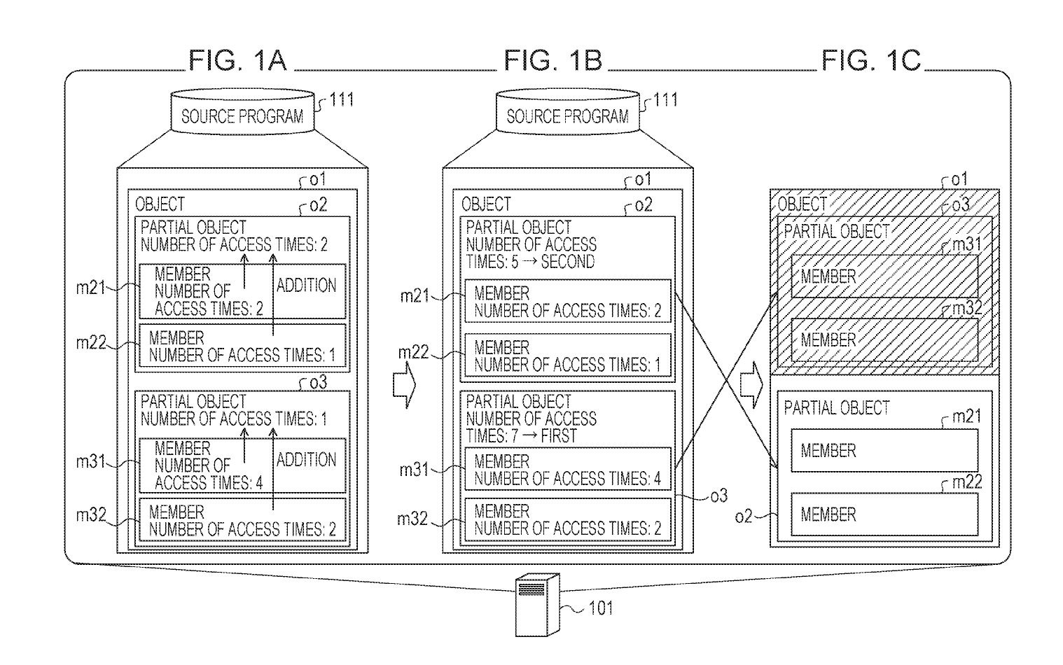

FIG. 1A to FIG. 1C are explanatory diagrams illustrating an operation example of a computer 101. The computer 101 illustrated in FIG. 1A to FIG. 1C is a computer that performs compiling. The computer 101 is, for example, an automatic computer. For example, the computer 101 compiles a source program prepared by a user and creates an executable program. Hereinafter, the executable program is referred to as “an object program”. Here, the created object program may target the computer 101 or may target another computer. The term “target” means a computer in which the object program is executed. In addition, the computer 101 is, for example, a computer used in a high performance computing (HPC) field.

The source program prepared by the user is written according to a programming language. Then, in order to make the created object program be a high-performance object program, it is preferable that the programming is performed while considering the performance.

Here, as a technology for improving the performance, for example, there is a technology in which a given source program is compiled while designating optimized compiling options, and then, the performance is evaluated. In addition, in a case where further improvement of the performance is desired, option tuning is considered to be performed, in which a plurality of optimized options is combined to be designated. In addition, it can be considered to perform the tuning operation at the source level while understanding the source program by extracting bottleneck processing using a tuning tool. As examples of the tuning operations, an operation of changing a loop structure in the source program, an operation of inserting a control line for instructing the optimization, and an operation of describing a property that makes it easy to apply the optimization on the frequently accessed variables, can be included.

However, in many cases, the tuning operation at the source level desires expertise and it is difficult for a general user to perform the tuning operation. In addition, in many cases, it takes a long time to perform the tuning operation even for highly experienced tuning personnel.

In addition, in a viewpoint of the programming language also, there is a factor that makes it difficult to perform the tuning operation. Here, in a process of compiling, there are a front end in which a lexical analysis, a syntax analysis, and a semantic analysis are performed, and a back end in which optimization processing and a generation of a code are performed. The processing in the front end is processing that depends on the specification of the programming language, and does not depend on the architecture of the target. On the other hand, the processing in the back end is processing that does not depend on the specification of the programming language and depends on the architecture of the target.

In the front end, intermediate language 1 information in which information such as a declaration, a statement, and an expression of the source program is held is generated from the original source program. Then, in the front end, the intermediate language 1 information is converted into intermediate language 2 information which is information close to the architecture of the target. Then, in the back end, the optimization is performed on the intermediate language 2 information, and the generation of the code is performed. Therefore, depending on the content of the original source program, there is a case where the optimization is not performed as much as expected by the user.

As an example of the optimization, in a programming language such as Fortran or C language, there is a technology in which data having a large number of access times in the class is easily stored in the target cache memory at the time of execution by moving the data having the large number of access times to the head side of the data, and thus, the improvement of the access performance can be achieved.

However, if there is a nested class in which other data is included in any of the data items included in the object specified in the source program, it is difficult to improve the access performance of the object program obtainable by compiling the source program. Specifically, for example, from the source program, even if the number of times the data outside of the nested class is written is construed as the number of access times of the data outside of the nested class, there is a problem in that it may not be the exact number of access times because the data inside of the nested class is not taken into consideration. Then, even if the arrangement of the data items is changed according to the inaccurate number of access times, the access performance of the object program is not improved. In addition, if the arrangement of the data items having the large number of access times is changed while ignoring the nested class, there is a problem in that the object program may not operate correctly.

Particularly, in an object-oriented language such as the C++C++ language, when the data is accessed to each object having a plurality of hierarchies, there is a possibility that all the data is accessed in the same address. Therefore, by only referring to the access frequency for each element, it is difficult to accurately detect the address in which the access frequency is high. For example, in the C++C++ language, a head address of the object of the derived class and a head address of the data of the base class in the derived class are the same. Here, the data of the base class in the derived class is referred to as a partial object, which is also referred to as a subobject in the C++ language.

Then, in the C++ language, in many cases, an expression for processing in a unit of a partial object is expressed, and in a processing logic of the C++ language, there is a case where the processing system internally generates the access to the partial object. Since the data structure of the partial object is similar to the data structure of the nested class, it is not possible to make only the member having the large number of access times in the base class be the changing target of the data structure. Furthermore, in the back end, the access to member is processed as “head address of the data+offset of the member+size of the member”. Therefore, in a case where the change of the data structure is attempted to be performed in the back end, since information on the partial object in the derived class is lost, it is not possible to check the access situation of the derived class that includes the partial object in which the target member is included.

Therefore, in the present embodiment, a method of determining an order of arrangement of each data based on each value obtained by adding the number of access times of each data included in each data to the number of access times of each data in the object at the time of compiling will be described. In the example described below, an example of writing the source program in the C++ language will be described. In the C++ language, the members are included in the object as the data. In addition, if the object is the derived class, the partial objects are included in the object as the data.

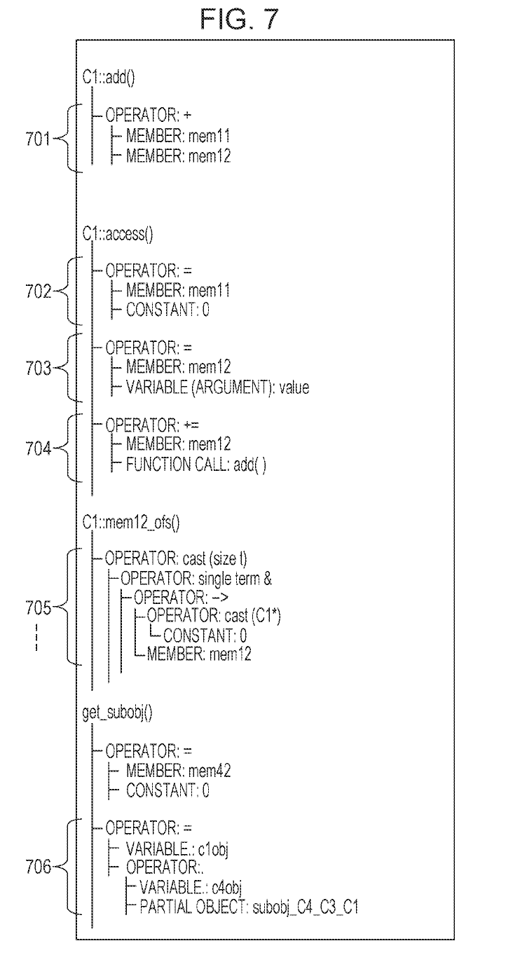

Operations of the computer 101 will be described using FIG. 1A to FIG. 1C. A source program 111 illustrated in FIG. 1A specifies an object o1. Then, the object o1 includes partial objects o2 and o3. The partial object o2 includes members m21 and m22. In addition, the partial object o3 includes members m31 and m32. Then, the number of access times of the object o2 itself is two. The number of access times of the members m21 and m22 are respectively two and one. In addition, the number of access times of the object o3 itself is one. The number of access times of the members m31 and m32 are respectively four and two. Here, each of the number of access times of the objects o1 to o3 and the members m21 to m32 in FIG. 1A are respectively obtained by counting the number of times expressed in the expression information included in the intermediate language 1 information. A specific example of the expression information included in the intermediate language 1 information is illustrated in FIG. 7.

The computer 101 adds the number of access times of the members m21 and m22 to the number of access times of the partial object o2, and adds the number of access times of the members m31 and m32 to the number of access times of the partial object o3. In the example in FIG. 1A, the computer 101 adds two and one which are the number of access times of the member m21 and m22 respectively to two which is the number of access times of the partial object o2, and then, obtains five. Similarly, the computer 101 adds four and two which are the number of access times of the members m31 and m32 respectively to one which is the number of access times of the partial object o3, and then, obtains 7.

Next, the computer 101 determines an arrangement order of the partial objects o2 and o3 when arranging the partial objects in the target storage region based on the resulting number of access times of the partial objects o2 and o3 after the addition. Specifically, as illustrated in FIG. 1B, the computer 101 determines the partial object o3 as the first and the partial object o2 as the second in descending order of the number of access times.

FIG. 1C illustrates an example when the object program after compiling is executed. The hatched region in FIG. 1C illustrates a region stored in the target cache memory. As described above, since the partial object o3 having a large number of access times is stored in the cache memory, the performance of access to the object o1 can be improved.

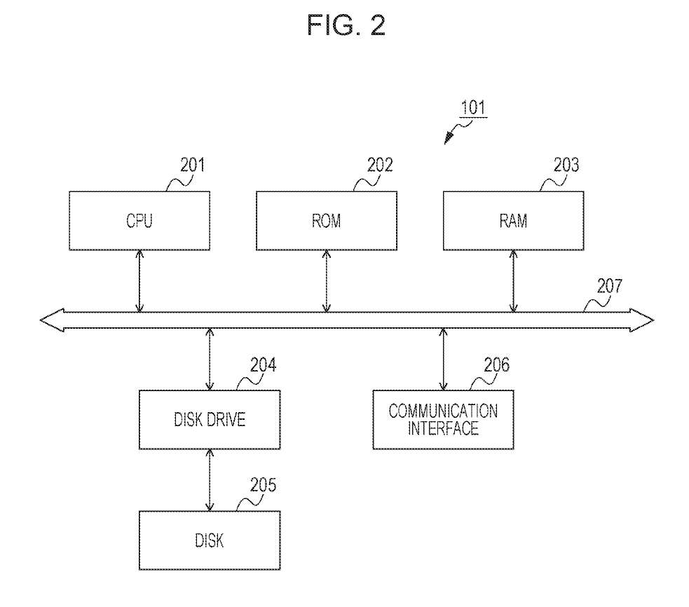

In the present embodiment, the description is made using the C++ language as an example of the programming language. However, the present embodiment can be applied to another object-oriented language such as JAVA®. Next, a hardware configuration of the computer 101 will be described using FIG. 2.

FIG. 2 is an explanatory diagram illustrating a hardware configuration example of the computer 101. In FIG. 2, the computer 101 includes a CPU 201, a read only memory (ROM) 202, and a random access memory (RAM) 203. In addition, computer 101 includes a disk drive 204, a disk 205, and a communication interface 206. In addition, the CPU 201 to the disk drive 204 and the communication interface 206 are connected to each other via a BUS 207.

The CPU 201 is an arithmetic processing unit that administrates the control of the entire computer 101. In addition, the computer 101 may include a plurality of CPUs. The ROM 202 is a non-volatile memory that stores programs such as a boot program. The RAM 203 is a volatile memory used as a work area of the CPU 201.

The disk drive 204 is a control device that controls reading or writing of the data with respect to the disk 205 according to the control of the CPU 201. For example, a magnetic disk drive, an optical disk drive, or a solid-state drive can be adopted as the disk drive 204. The disk 205 is a non-volatile memory that stores the data written by the control of the disk drive 204. For example, in a case where the disk drive 204 is the magnetic disk drive, the magnetic disk can be adopted as the disk 205. In addition, in a case where the disk drive 204 is an optical disk drive, an optical disk can be adopted as the disk 205. In a case where the disk drive 204 is the solid-state drive, a semiconductor memory formed by a semiconductor element, a so-called semiconductor disk, can be adopted as the disk 205. The source program may be stored in the disk 205 and transferred to RAM 203 when being compiled, or may be received through the communication interface 206 and stored in the RAM 203. The disk 205 and RAM 203 are examples of a storage unit for storing a source program.

The communication interface 206 administrates the interface between the network and the inside of the computer, and controls the input and output of the data to and from another device. Specifically, the communication interface 206 is connected to another device such as a user terminal that uses the computer 101 via the network through the communication lines. For example, a modem or a local area network (LAN) adapter can be adopted as the communication interface 206.

In addition, in a case where an administrator of the computer 101 directly operates the computer 101, the computer 101 may include hardware such as a display, a keyboard, or a mouse.

[Functional Configuration Example of the Computer 101]

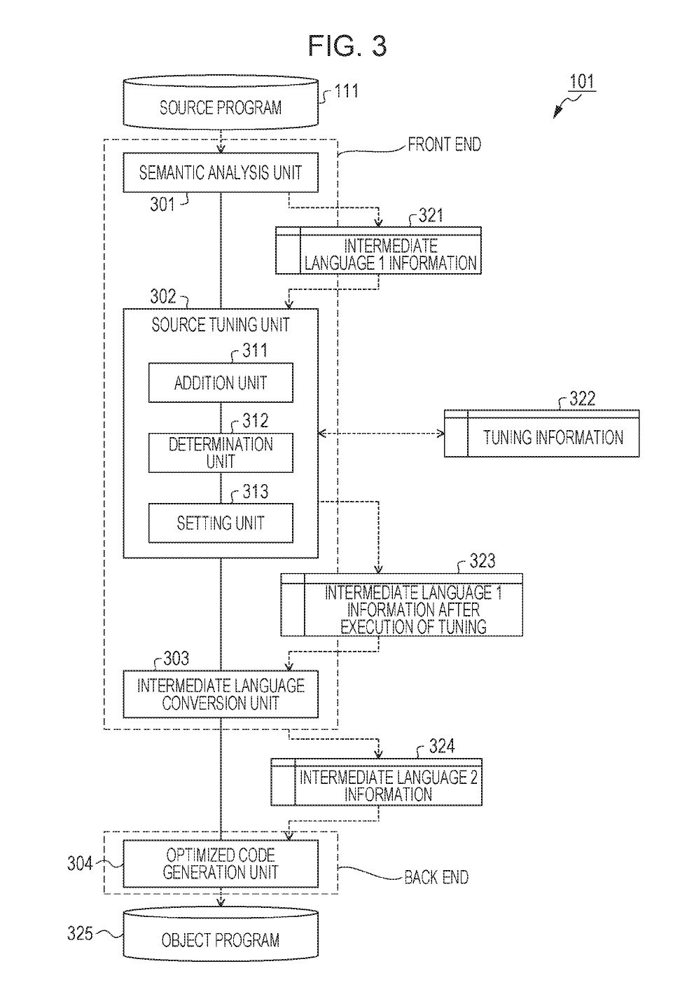

FIG. 3 is an explanatory diagram illustrating a functional configuration example of the computer 101. The computer 101 includes CPU 201 which may be a processor and executes a process as a control unit. The control unit includes a semantic analysis unit 301, a source tuning unit 302, an intermediate language conversion unit 303, and an optimized code generation unit 304. Here, the semantic analysis unit 301 to the intermediate language conversion unit 303 correspond to the front end described in FIGS. 1A to 1C. In addition, the optimized code generation unit 304 corresponds to the back end described in FIGS. 1A to 1C.

The source tuning unit 302 includes an addition unit 311, a determination unit 312, and a setting unit 313. The control unit realizes the function of each unit by the CPU 201 executing the program stored in the storage device. Specifically, for example, the storage device is the ROM 202, the RAM 203, the disk 205, or the like illustrated in FIG. 2. In addition, the result of processing by each unit is stored in the register of the CPU 201, in the cache memory of the CPU 201 or in the RAM 203.

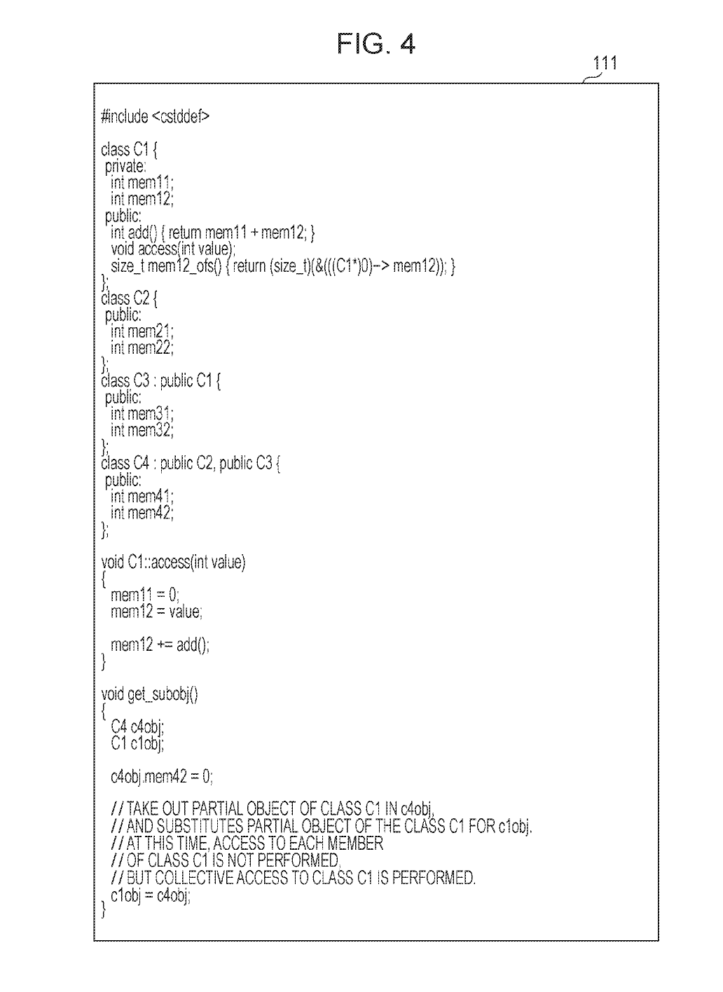

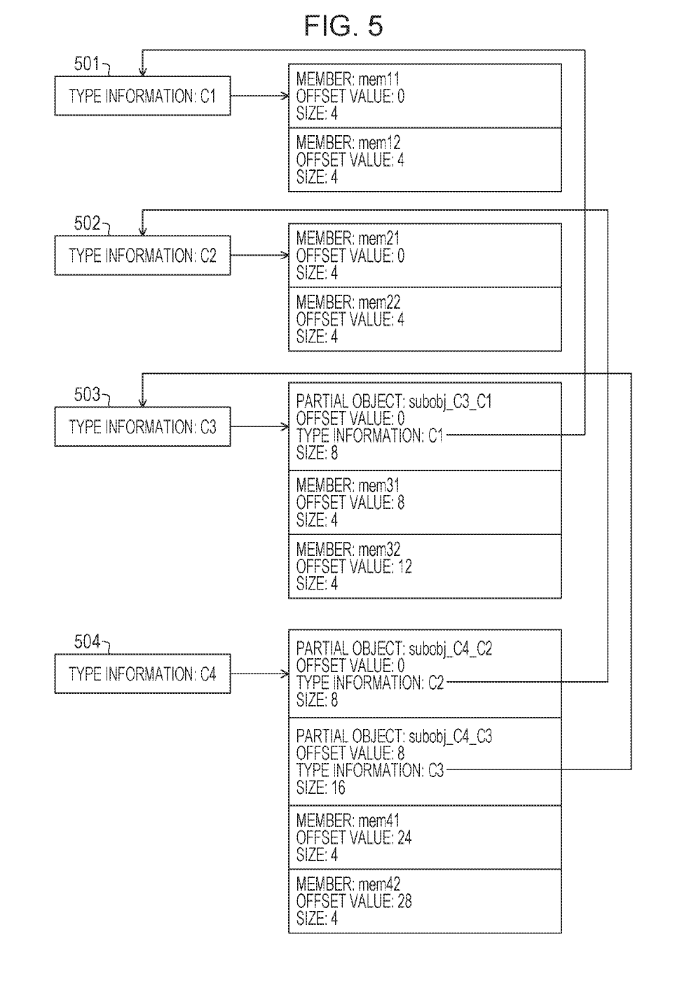

The semantic analysis unit 301 reads the source program 111 and performs the semantic analysis, and generates intermediate language 1 information 321. The specific example of the source program 111 is illustrated in FIG. 4. The type information and the expression information are included in the intermediate language 1 information 321. The specific example of the type information of the intermediate language 1 information 321 is illustrated in FIG. 5. In addition, the specific example of the expression information of the intermediate language 1 information 321 is illustrated in FIG. 7.

The source tuning unit 302 performs source tuning of the intermediate language 1 information 321 using the tuning information 322, and then, generates tuning-executed intermediate language 1 information 323. Specifically, the source tuning unit 302 performs the source tuning in three phases described below.

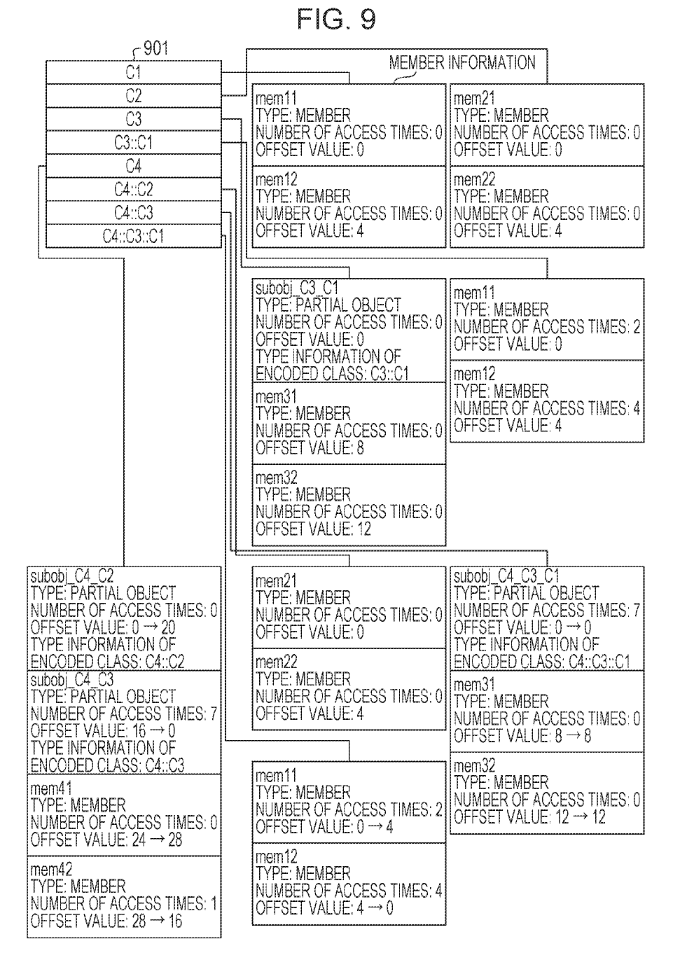

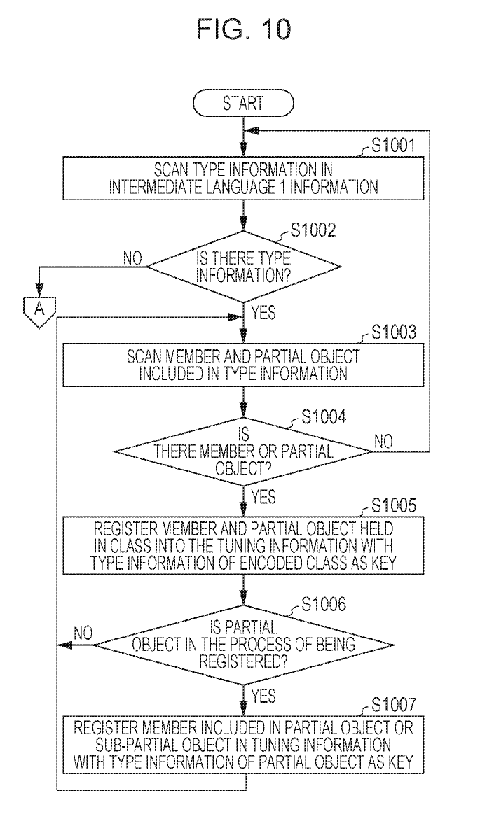

The first phase is processing that collects the number of access times. Specifically, the source tuning unit 302 performs scanning on the intermediate language 1 information 321 and collects the numbers of access times of the member and the partial object (or subobject) which is individually accessed. The collected information is written in the tuning information 322 in the unit of the type information. Here, the addition unit 311 included in the source tuning unit 302 adds the numbers of access times of the included partial objects and the members to the number of access times of the partial object itself. Then, the addition unit 311 treats the value obtained by the addition as the number of access times of the partial object. In this way, the priority of the movement of the partial objects in which the member having the large number of access times is included becomes high at the time of rearrangement. The specific example of the tuning information 322 is illustrated in FIG. 9. In addition, a flowchart illustrating the processing that collects the number of access times is illustrated in FIG. 10 to FIG. 12.

The second phase is processing that determines the arrangement position of the members and the partial objects. The determination unit 312 included in the source tuning unit 302 determines the order of the members and the partial objects based on the number of access times of the members and the partial objects written in the tuning information 322. For example, the determination unit 312 determines the order in such a manner that the member and the partial object having the large number of access times come to the head with priority. In addition, the determination unit 312 may determine the order in such a manner that the member and the partial object having small number of access times come to the end.

In addition, in a case of the member and the partial object having the same numbers of access times, the determination unit 312 may determine the ascending order of the size of the member and the partial object as the order of the member and the partial object.

In addition, the determination unit 312 determines an offset value of the member and the partial object based on the determined order of the member and the partial object and the sizes of the member and the partial object obtainable from the type information of the intermediate language 1 information 321.

For example, it is assumed that a certain object has three partial objects and the order thereof is determined. In this case, the determination unit 312 sets the offset value of the partial object determined to be the first as zero. In addition, the determination unit 312 sets the offset value of the partial object determined to be the second as the size of the partial object determined to be the first. Furthermore, the determination unit 312 sets the offset value of the partial object determined to be the third as the sum of the sizes of the partial objects determined to be the first and the second. In addition, if an alignment such as a 4-byte boundary or an 8-byte boundary is set by a compiler option, the determination unit 312 determines the offset value of the member and the partial object according to the determined order and the alignment.

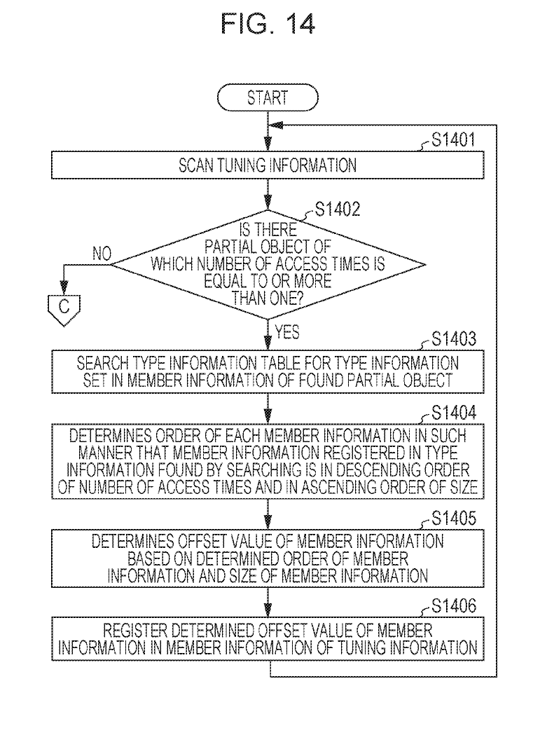

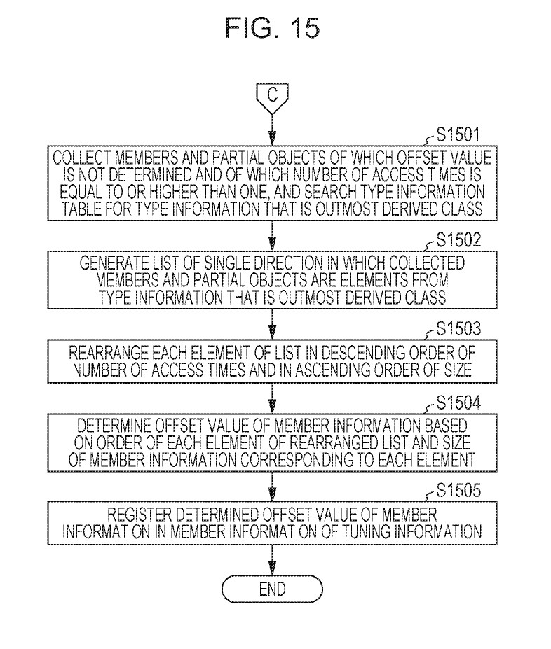

The flowchart for the processing that determines the arrangement position of the member and the partial object which is the second phase is illustrated in FIG. 14 and FIG. 15.

The third phase is processing that uses the determined offset value. Specifically, the source tuning unit 302 performs the change of the data structure on the intermediate language 1 information 321 using the determined offset value, and obtains the intermediate language 1 information 323. At this time, the setting unit 313 included in the source tuning unit 302 sets the determined offset value as a result of calculating an instruction to acquire the offset value of the member and the partial object. An example of the instruction to acquire the offset value of the member and the partial object is illustrated in FIG. 7.

The intermediate language conversion unit 303 generates intermediate language 2 information 324 from the intermediate language 1 information 323. The optimized code generation unit 304 generates object program 325 from the intermediate language 2 information 324.

FIG. 4 is an explanatory diagram illustrating an example of the source program 111 written in C++ language. The source program 111 illustrated in FIG. 4 defines classes C1 to C4 and a get_subobj( ) function. Here, “subobj( )” means the subobject or the partial object.

The class C1 includes member variables mem11 and mem12, and includes a member function add( ) an access( ) and a mem12_ofs( ). The class C2 includes member variables mem21 and mem22.

The class C3 is a derived class having the class C1 as the base class. Furthermore, the class C3 includes the member variables mem31 and mem32.

The class C4 is a derived class having the class C2 and the class C3 as the base class. Furthermore, the class C4 includes member variables mem41 and mem42.

The get_subobj( ) function secures object c4obj of the class C4 and object clobj of the class C1 as local variables, and then, substitutes zero for the member variable mem42 of the object c4obj. Then, the get_subobj( ) function takes out the partial object of the class C1 in the c4obj, and substitutes the partial object of the class C1 for the clobj. At this time, the access to each member of the class C1 is not performed, but the collective access to the class C1 is performed.

FIG. 5 is an explanatory diagram illustrating an example of the type information of the intermediate language 1 information 321 before the source tuning. The type information includes equal to or more than one member or the partial object. In FIG. 5, the type information items 501 to 504 of the intermediate language 1 information 321 obtained by the semantic analysis of the source program 111 are illustrated. Here, the partial object is the data of the base class in the derived class. In addition, the name of the partial object is referred to as “subobj_derived class_base class”. In addition, the name of the partial object of a derived class 2 further derived from a derived class 1 is referred to as “subobj_derived class 2_derived class 1_base class”.

In addition, the member included in the type information includes the name of the member, the offset value of the member, and the size of the member. The offset value from the head address where the object of the class indicated by the type information is arranged is stored in the offset value of the member as the head address where the member is arranged. In addition, in the size of the member, the size of the member is stored.

In addition, the partial object included in the type information includes the name of the partial object, the offset value of the partial object, the type information of the partial object, and the size of the partial object. The offset value from the head address where the object of the class indicated by the type information is arranged is stored in the offset value of the member as the head address where the partial object is arranged. In the type information of the partial object, the type information of the partial object is stored. In addition, in the size of the partial object, the size of the partial object is stored.

Hereinafter, the member included in the illustrated type information is illustrated with the name of the member being assigned as a symbol. Similarly, the partial object included in the illustrated type information is illustrated with the name of the partial object being assigned as a symbol.

For example, the type information of the class C1 which becomes the type information 501 includes a member mem11 and a member mem12. Then, it is indicated that the member mem11 has the offset value zero, that is, the member mem11 is arranged at the head address where the object of the class C1 is arranged, and the size thereof is four. In addition, it is indicated that the member mem12 has the offset value four, that is, the member mem12 is arranged at the address where four is added to the head address where the object of the class C1 is arranged, and the size thereof is 4.

In addition, the type information of the class C2 which becomes the type information 502 includes a member mem21 and a member mem22.

In addition, the type information of the class C3 which becomes the type information 503 includes a partial object subobj_C3_C1 and a member mem31 and a member mem32. Then, for example, it is indicated that the partial object subobj_C3_C1 has the offset value zero, that is, the partial object subobj_C3_C1 is arranged at the address where the object of the class C3 is arranged, the type information is C1, and the size thereof is eight.

The type information of the class C4 which becomes the type information 504 includes a partial object subobj_C4_C2, a partial object subobj_C4_C3, a member mem41, and a member mem42. Then, for example, it is indicated that the partial object subobj_C4_C2 has the offset value zero, that is, the partial object subobj_C4_C2 is arranged at the head address where the object of the class C4 is arranged, the type information is C2, and the size thereof is eight. In addition, it is indicated that the partial object subobj_C4_C3 has the offset value eight, that is, the partial object subobj_C4_C3 is arranged at the head address where eight is added to the address where the object of class C4 is arranged, the type information is C2, and the size thereof is eight.

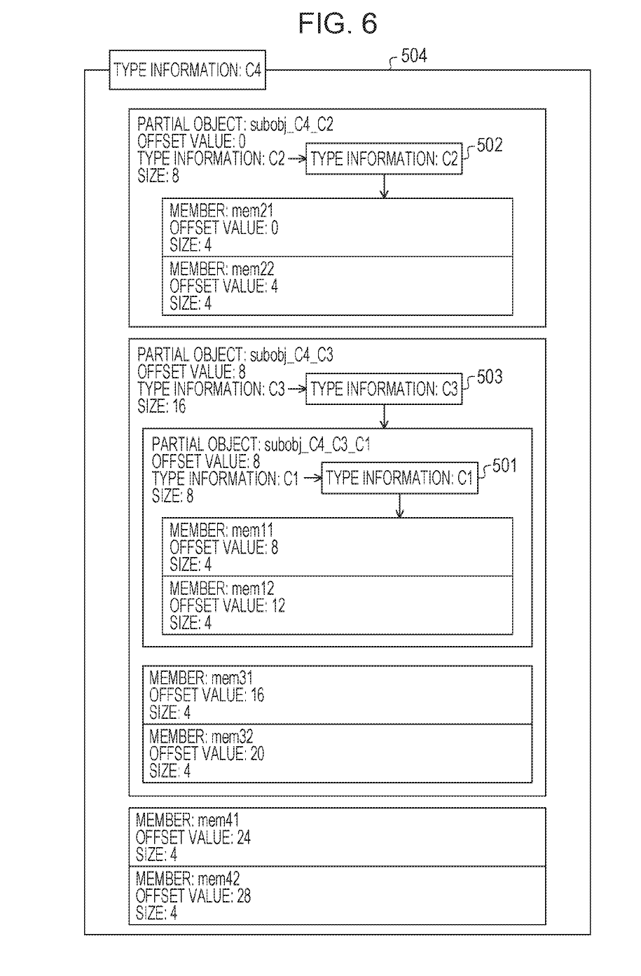

FIG. 6 is an explanatory diagram illustrating an example of the data structure before the source tuning. FIG. 6 illustrates a data structure of the c4obj in the get_subobj ( ) function illustrated in FIG. 4 in a case according to the type information of the class C4 illustrated in FIG. 5.

The data structure of the c4obj is a structure of being arranged in the storage region in the order of the partial object subobj_C4_C2, the partial object subobj_C4_C3, the member mem41, and the member mem42 according to the type information of the class C4 which becomes the type information 504.

In addition, the data structure of the partial object tsubobj_C4_C2 is a structure of being arranged in the storage region in the order of the member mem21 and the member mem22 according to the type information of the class C2 which becomes the type information 502.

In addition, the data structure of the partial object subobj_C4_C3 is a structure of being arranged in the storage region in the order of the partial object subobj_C4_C3_C1, the member mem31, and the member mem32 according to the type information of the class C3 which becomes the type information 503. Furthermore, the data structure of the partial object subobj_C4_C3_C1 is a structure of being arranged in the storage region in the order of the member mem11 and the member mem12 according to the type information of the class C1 which becomes the type information 501.

FIG. 7 is an explanatory diagram illustrating an example of expression information of the intermediate language 1 information 321 before the source tuning. FIG. 7 illustrates expression information items 701 to 706 of the intermediate language 1 information obtainable from the semantic analysis of the source program 111.

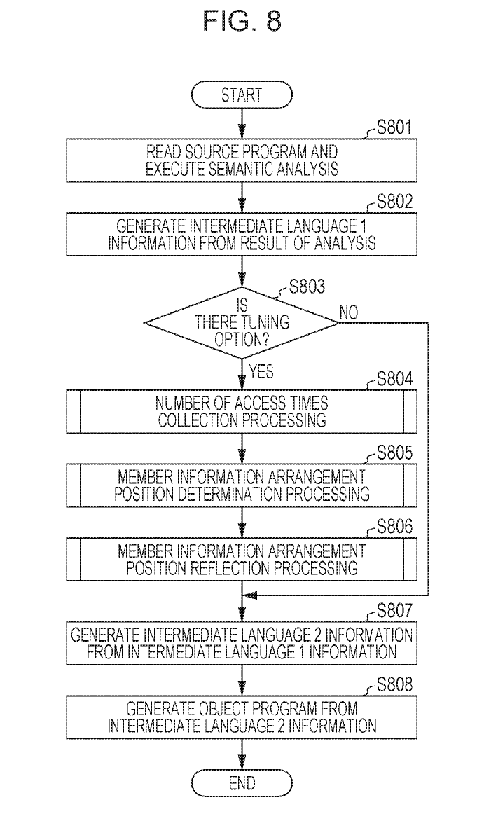

For example, the expression information 701 indicates that an operator thereof is “+” and the member accessed by executing the operator “+” is the member mem11 and the member mem12. Next, the compiling processing performed by the computer 101 will be described using FIG. 8.

In addition, an example of the instruction to acquire the offset value of the member and the partial object described in FIG. 3 is the expression information 705. The expression information 705 is an instruction to acquire the offset value of the member mem12. Before the source tuning, the offset value of the member mem12 is four as indicated in the type information 501.

In addition, the expression information 706 is a simple assignment statement saying “c1obj=c4obj” in the source program 111 and includes C1 which is a part of the c4obj. Therefore, the computer 101 automatically generates the expression “c1obj=c4obj.subobj_C4_C3_C1” instead of “c1obj=c4obj” at the time of generating the intermediate language 1 information 321.

Next, flowcharts describing the operations executed by the computer 101 are illustrated in FIG. 8 to FIG. 15.

FIG. 8 is a flowchart illustrating an example of a compiling processing procedure. The compiling processing is processing that compiles the source program 111. The computer 101 reads the source program and executes the semantic analysis (STEP S801). Next, the computer 101 generates the intermediate language 1 information 321 from the result of the analysis (STEP S802). Then, the computer 101 checks whether or not there are tuning options for compiling (STEP S803). In a case where there are tuning options (Yes in STEP S803), the computer 101 executes the number of access times collection processing (STEP S804). The number of access times collection processing will be described using FIG. 10 to FIG. 12.

Next, the computer 101 executes the member information arrangement position determination processing (STEP S805). The member information arrangement position determination processing will be described using FIG. 14. Then, the computer 101 executes the member information arrangement position reflection processing (STEP S806).

After the processing in STEP S806 ends or in a case where there is no tuning option (No in STEP S803), the computer 101 generates the intermediate language 2 information 324 from the intermediate language 1 information 321 or the tuning-executed intermediate language 1 information 323 (STEP S807). Then, the computer 101 generates the object program 325 from the intermediate language 2 information 324 (STEP S808). After the processing in STEP 808 ends, the computer 101 ends the compiling processing. By executing the compiling processing, even in the program using the class, the computer 101 can generate the object program of which the data structure is changed.

Next, the tuning information 322 generated by the compiling processing will be described using FIG. 9.

FIG. 9 is an explanatory diagram illustrating an example of stored content of tuning information 322. The tuning information 322 includes a type information table 901 and member information. The type information table 901 is a table in which the type information of the encoded class is stored. Here, the type information of the encoded class is type information encoded such that the access situation from the derived class to the base class can be understood.

The type information table 901 illustrated in FIG. 9 includes eight encoded type information items such as C1, C2, C3, C3::C1, C4, C4::C2, C4::C3, and C4::C3::C1. Then, each encoded type information is associated with the member information. Hereinafter, the member information associated with the encoded type information will be indicated by being given a sign encoded type information member name.

The member information associated with the encoded type information includes items of type, the number of access times, and the offset value. The item of type indicates the type of the member information. Specifically, any one of a “member” identifier or a “partial object” identifier is stored in the item of type. The number of access times indicates the number of access times to the member indicated by the member or the partial object. The offset value indicates the offset value from the head address of the object in the encoded type information. Here, among the offset values illustrated in FIG. 9, in the offset values of which the values are updated by the arrows, the values on the left of the arrows indicate the values at the time when the number of access times collection processing ends. In addition, the values on the right of the arrows indicate the values at the time when the member information arrangement position determination processing ends. In addition, the member information of which the item of type is the “partial object” identifier further includes an item of the type information of the encoded class. The type information of the encoded class indicates the type information of the encoded class of the partial object.

For example, the encoded type information C1 includes member information items C1_mem11 and C1_mem12. For example, in the member information C1_mem12, it is indicated that the type is a member, the number of access times is zero, and the offset value is four. A specific example of updating the number of access times and the offset value will be described using each processing in the number of access times collection processing and the member information arrangement position determination processing.

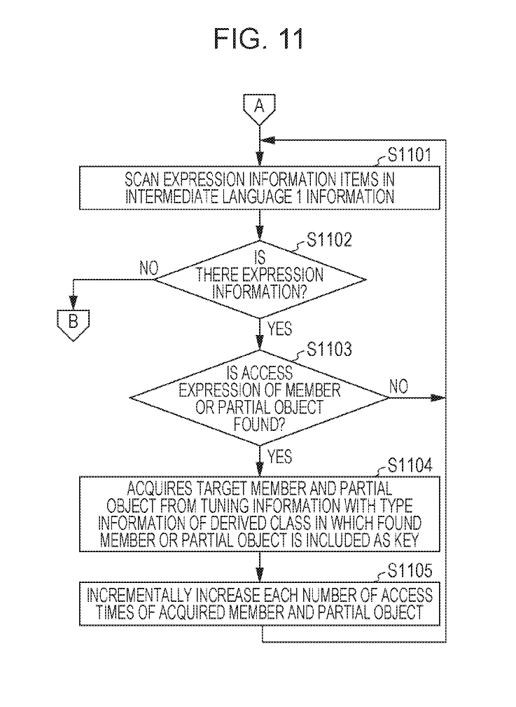

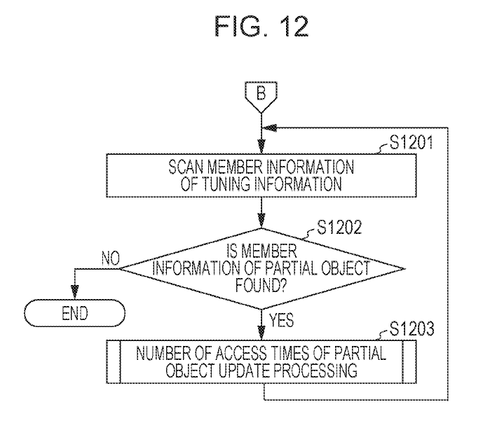

FIG. 10 is a flowchart (part 1) illustrating an example of a number of access times collection processing procedure. In addition, FIG. 11 is a flowchart (part 2) illustrating the example of the access times collection processing procedure. In addition, FIG. 12 is a flowchart (part 3) illustrating the example of the access times collection processing procedure. The number of access times collection processing is processing that counts the number of access times.

The computer 101 scans the type information in the intermediate language 1 information 321 (STEP S1001). Hereinafter, in the scanning processing, when starting the next scanning after detecting a target, the computer 101 starts the scanning from the position next to the position where the target is detected.

As a result of the scanning, the computer 101 determines whether or not there is the type information in the intermediate language 1 information 321 (STEP S1002). In a case where there is the type information (Yes in STEP S1002), the computer 101 scans the member and the partial object included in the type information (STEP S1003). Then, as the result of the scanning, the computer 101 determines whether or not there is the member or the partial object (STEP S1004). In a case where there is no member nor the partial object (No in STEP S1004), the computer 101 moves to the processing in STEP S1001 for scanning another type information.

On the other hand, in a case where there is the member or the partial object (Yes in STEP S1004), the computer 101 registers the member and the partial object held in the class in the tuning information 322 as the registration of the member or the partial object with the type information of the encoded class as a key (STEP S1005). At this time, the computer 101 creates the member information so as to be used as an index in the type information table 901. Specifically, for example, the computer 101 stores the head address of the created member information and the member information of the encoded class in the type information table 901 as one record. In addition, the computer 101 sets the number of access times of the created member information to be zero. In addition, the computer 101 sets the offset value of the created member information to be the same as the offset value of the type information of the intermediate language 1 information 321.

Next, the computer 101 determines whether or not the partial object is in the process of being registered (STEP S1006). In a case where the partial object is in the process of being registered (Yes in STEP S1006), the computer 101 registers the member included in the partial object or a sub-partial object in the tuning information 322 with the type information of the partial object as a key (STEP S1007). Here, when registering the tuning information 322, the processing in STEP S1003 and the processing in STEP S1005 are applied to the member included in the partial object or the sub-partial object. In addition, in a case where the sub-partial object further includes a partial object, the computer 101 recursively repeats the processing in STEP S1003 and the processing in STEP S1005.

In STEP S1007 or in a case where the partial object is not in the process of being registered (No in STEP S1006), the computer 101 moves the process to the processing in STEP S1003. In addition, in a case where there is no type information (No in STEP S1002), it means that the computer 101 finished the registration of all the member information of tuning information 322. Then, the computer 101 scans the expression information items in the intermediate language 1 information 321 (STEP S1101).

As a result of scanning, the computer 101 determines whether or not there is the expression information (STEP S1102). In a case where there is the expression information (Yes in STEP S1102), the computer 101 determines whether or not an access expression of the member or the partial object is found (STEP S1103). Here, as the processing that finds the access expression of the member or the partial object, if the member or the partial object name is included in the member or the partial object of the expression information, the computer 101 assumes that the access expression of the member or the partial object is found.

In a case where the access expression of the member or the partial object is found (Yes in STEP S1103), the computer 101 acquires the target member and the partial object from the tuning information 322 with the type information of the derived class in which found member or the partial object is included as a key (STEP S1104). Then, the computer 101 incrementally increases the number of access times of the acquired member and partial object (STEP S1105).

Specifically, for example, in STEP S1102, it is assumed that there is the expression information 701. In this case, there are members mem11 and mem12 in the expression information 701 as the member. Therefore, in STEP S1104, the computer 101 sets the derived class in which the found members mem11 and mem12 are included as the key. Then, the computer 101 acquires the member information items C3::C1_mem11 and C3::C1_mem12, and member information items C3::C1_mem11 and C3::C1_mem12 from the tuning information 322, and then, incrementally increases each number of access times. The member information items C1_mem11 and C1_mem12 may not be incrementally increased because the member information items C1_mem11 and C1_mem12 are the member information of the type information of the base class.

After the processing in STEP S1105 ends, or in a case where the access expression of the member and the partial object is not found (No in STEP S1103), the computer 101 moves the process to the processing in STEP S1101 to scan another expression information.

In a case where there is no expression information (No in STEP S1102), it means that the computer 101 finished the direct counting of the number of access times in the member information of the tuning information 322. In the stage of No in STEP S1102, the member information described below has the number of access times equal to or higher than one. The member information, and the number of access times of the member information are described below in combination with each other.

member information C3::C1_mem11, number of access times: 2

member information C3::C1_mem12, number of access times: 4

member information C4_mem42, number of access times: 1

member information C4::C3_subobj_C4_C3_C1, number of access times: 1

member information C4::C3::C1_mem11, number of access times: 2

member information C4::C3::C1_mem12, number of access times: 4

The number of access times of the member information C4::C3_subobj_C4_C3_C1 is different from the value illustrated in FIG. 9. However, it is because, in this stage, the number of access times of the member information C4::C3_subobj_C4_C3_C1 itself is illustrated. By executing the update processing on the number of access times of the partial object described below, the number of access times of the member information C4::C3_subobj_C4_C3_C1 becomes the value illustrated in FIG. 9.

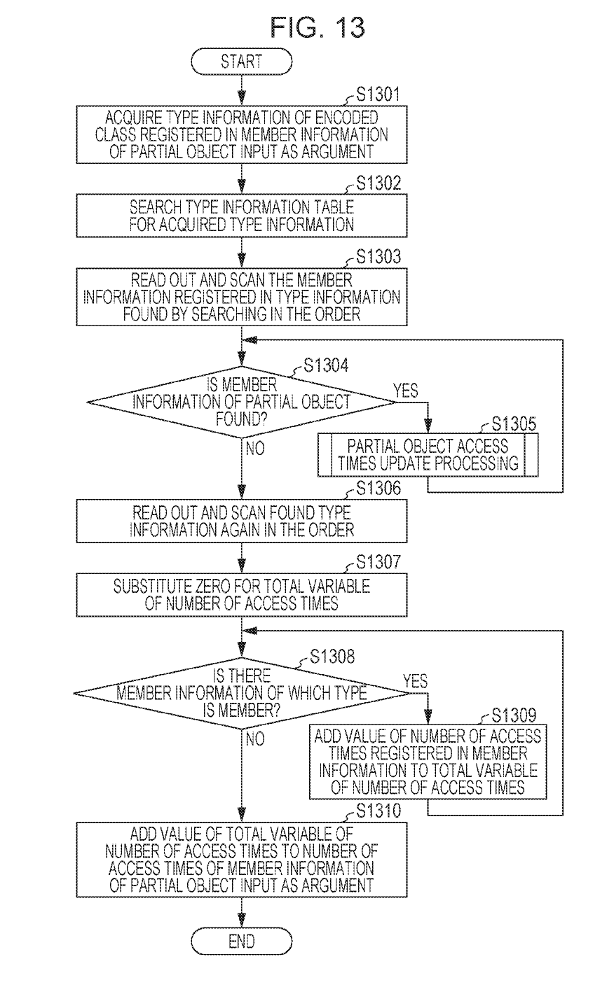

In a case where the result of STEP S1102 is No, the computer 101 scans the member information of the tuning information 322 (STEP S1201). As a result of scanning, the computer 101 determines whether or not the member information of the partial object is found (STEP S1202). In a case where the member information of the partial object is found (Yes in STEP S1202), the computer 101 executes the partial object access times update processing with the found partial object as an argument (STEP S1203). The partial object access times update processing will be described using FIG. 13.

On the other hand, in a case where the member information of the partial object is not found (No in STEP S1202), the computer 101 ends the number of access times collection processing. By executing the number of access times collection processing, the computer 101 can acquire the accurate number of access times of the tuning information 322.

FIG. 13 is a flowchart illustrating an example of the partial object access times update processing procedure. The partial object access times update processing is processing that updates the number of access times to each member information which becomes the partial object.

The computer 101 acquires the type information of the encoded class registered in the member information of the partial object input as the argument (STEP S1301). Next, the computer 101 searches the type information table 901 for the acquired type information (STEP S1302). Then, the computer 101 reads out and scans the member information registered in the type information found by searching in order (STEP S1303).

As a result of scanning, the computer 101 determines whether or not the member information of the partial object is found (STEP S1304). In a case where the member information of the partial object is found (Yes in STEP S1304), the computer 101 executes the partial object access times update processing with the found partial object as the argument (STEP S1305). Then, the computer 101 moves the process to STEP S1304.

On the other hand, in a case where the member information of the partial object is not found (No in STEP S1304), the computer 101 reads out and scans the found type information again in order (STEP S1306). Then, the computer 101 substitutes zero for a total variable of the number of access times which is a local variable used in the partial object access times update processing (STEP S1307).

As a result of scanning, the computer 101 determines whether or not there is the member information of which the type is a member in the type information (STEP S1308). In a case where there is the member information of which the type is a member (Yes in STEP S1308), the computer 101 adds the value of the number of access times registered in the member information to the total variable of the number of access times (STEP S1309). Then, the computer 101 moves the process to STEP S1308.

On the other hand, in a case where there is no member information of which the type is a member (No in STEP S1308), the computer 101 adds the value of the total variable of the number of access times to the number of access times of the member information of the partial object input as the argument (STEP S1310). After ending the processing in STEP S1310, the computer 101 ends the partial object access times update processing.

Here, the partial object access times update processing will be described using the example of the member information C4_subobj_C4_C3. In the processing in STEP S1202, the computer 101 reads out the partial object access times update processing with the member information C4_subobj_C4_C3 as the argument since the member information C4_subobj_C4_C3 is the member information of the partial object.

Then, in the processing in STEP S1301, the computer 101 acquires the type information C4::C3 of the encoded class of the member information C4_subobj_C4_C3 input as the argument. Next, the computer 101 finds the member information C4::C3_subobj_C3_C1 from the type information C4::C3 of the encoded class, and reads out again the partial object access times update processing with the member information C4::C3_subobj_C4_C3_C1 as the argument.

In the processing in STEP S1301, the computer 101 acquires the type information C4::C3::C1 of the encoded class of the member information C4::C3_subobj_C4_C3_C1 input as the argument. Next, in the processing in STEP S1309, the computer 101 adds the values two and four which are the numbers of access times of the member information items C4::C3::C1_mem11 and mem12 of the type information C4::C3::C1 of the encoded class to the total variable of the number of access times respectively. Then, in the processing in STEP S1310, the computer 101 adds the value of the total variable of the number of access times to the number of access times of the member information C4::C3_subobj_C4_C3_C1 input as the argument. At this time point, the number of access times of the member information C4::C3_subobj_C4_C3_C1 becomes 1+(2+4)=7.

Then, the computer 101 returns to the first partial object access times update processing. Next, in the processing in STEP S1310, the computer 101 makes the number of access times of the member information C4_subobj_C3_C1 seven by adding the number of access times of the member information C4::C3_subobj_C4_C3_C1.

By executing the partial object access times update processing, the computer 101 can obtain accurate number of access times to each member information while considering the number of access times to each member information itself and the number of access times to the member information included in each member information.

FIG. 14 is a flowchart (part 1) illustrating an example of the member information arrangement position determination processing procedure. In addition, FIG. 15 is a flowchart (part 2) illustrating the example of the member information arrangement position determination processing procedure. The computer 101 scans the tuning information 322 (STEP S1401).

As a result of scanning, the computer 101 determines whether or not there is a partial object of which the number of access times is equal to or higher than one (STEP S1402). In a case where there is the partial object of which the number of access times is equal to or higher than one (Yes in STEP S1402), the computer 101 searches the type information table 901 for the type information set in the member information of the found partial object (STEP S1403). Then, the computer 101 determines the order of each member information in such a manner that the member information registered in the type information found by searching is in descending order of the number of access times and in ascending order of the size (STEP S1404). Then, the computer 101 determines the offset value of the member information based on the determined order of the member information and the size of the member information (STEP S1405). Next, the computer 101 registers the determined offset value of the member information in the member information of the tuning information (STEP S1406).

Here, in a case where the partial object has a sub-partial object, the computer 101 applies the processing tasks from STEP S1402 to STEP S1406 to the sub-partial object.

The processing tasks in STEP S1402 to STEP S1406 will be described using the specific example. The computer 101 scans the tuning information 322, and determines whether or not there is the partial object of which the number of access times is equal to or more than one in the type information C4 of the encoded class in the processing in STEP S1402. In this case, since there is a member information C4_subobj_C4_C3 that satisfies the condition, in the processing in STEP S1403, the computer 101 searches the type information table 901 for the type information C4::C3 set in the member information of the found partial object.

Then, in the processing in STEP S1404, the computer 101 determines the order of each member information in such a manner that the member information items C4::C3_subobj_C4_C3_C1_mem31 and mem32 are in descending order of the number of access times and in ascending order of the size. In this case, since the number of access times of the member information C4::C3_subobj_C4_C3_C1 is the highest, the computer 101 determines that the member information C4::C3_subobj_C4_C3_C1 is first. Regarding the member information items C4::C3_mem31 and mem32, since both the numbers of access times and the sizes are the same, the computer 101 determines that the member information C4::C3_mem31 is second and the member information C4::C3_mem32 is third as the order as it is.

Then, in the processing in STEP S1405, the computer 101 determines the offset value of the member information based on the member information items C4::C3_subobj_C4_C3_C1_mem31 and mem32 which is the order of the determined member information and the size of the member information. In this case, consequently, the order is not changed, and thus, the offset value of the member information is not changed.

In addition, the member information C4_subobj_C4_C3 includes the member information C4::C3_subobj_C4_C3_C1. Therefore, the computer 101 applies the processing tasks STEP S1402 to STEP S1406 to the member information C4::C3_subobj_C4_C3_C1. In the processing in STEP S1404, the computer 101 determines the order of each member information in such a manner that the member information items C4_C3_C1_mem11 and mem12 included in the type information C4_C3_C1 of the encoded class are in descending order of the number of access times and in ascending order of the size. In this case, since the number of access times of the member information C4_C3_C1_mem12 is the highest, the computer 101 determines that the member information C4_C3_C1_mem12 is first and the member information C4_C3_C1_mem11 is second.

Then, in the processing in STEP S1405, the computer 101 determines the offset value of the member information based on the member information items C4_C3_C1_mem12 and mem11 which is the order of the member information and the size of the member information. In this case, the computer 101 determines the offset value of the member information C4_C3_C1_mem12 determined as first to be zero. Furthermore, the computer 101 determines the offset value of the member information C4_C3_C1_mem11 determined as second to be four which is the size of the member information C4_C3_C1_mem11.

In a case where there is no partial object of which the number of access times is equal to or higher than one (No in STEP S1402), the computer 101 collects the members and the partial objects of which the offset value is not determined and of which the number of access times is equal to or higher than one, and searches the type information table 901 for the type information that is the outmost derived class (STEP S1501).

Next, the computer 101 generates a list of a single direction in which the collected members and the partial objects are elements from the type information that is the outmost derived class (STEP S1502).

Next, the computer 101 rearranges each element of the list in descending order of the number of access times and in ascending order of the size (STEP S1503). Then, the computer 101 determines the offset value of the member information based on the order of each element of the rearranged list and the size of the member information corresponding to each element (STEP S1504). Next, the computer 101 registers the determined offset value of the member information in the member information of the tuning information 322 (STEP S1505). After ending the processing in STEP S1505, the computer 101 ends the member information arrangement position determination processing.

The processing tasks in STEP S1501 to STEP S1504 will be described using the specific example. At the time point when the result in STEP S1402 is No, the member and the partial object of which the offset value is not determined and of which the number of access times is equal to or higher than one is the member information C4_subobj_C4_C3_mem42. In the processing in STEP S1501, the computer 101 searches the type information table 901 for the type information C4 that is the outmost derived class of the member information C4_subobj_C4_C3_mem42.

Then, in the processing in STEP S1502, the computer 101 generates the list of a single direction in which the member information C4_subobj_C4_C3 and C4_mem42 are the elements from the type information C4. The head element of the generated list includes an address indicating the member information C4_subobj_C4_C3 and an address indicating the next element. The second element of the generated list includes the member information C4_mem42.

Next, in the processing in STEP S1503, the computer 101 rearranges the generated list in descending order of the number of access times and in ascending order of the size (STEP S1503). In this example, since the number of access times of the member information C4_subobj_C4_C3 is the highest, the computer 101 keeps the order as it is without changing the order.

Then, in the processing in STEP S1504, the computer 101 determines that the offset value of the member information C4_subobj_C4_C3 corresponding to the first element of the list is zero. In addition, the computer 101 determines that the offset value of the member information C4_mem42 corresponding to the first element of the list is 16 which is the size of the member information C4_subobj_C4_C3.

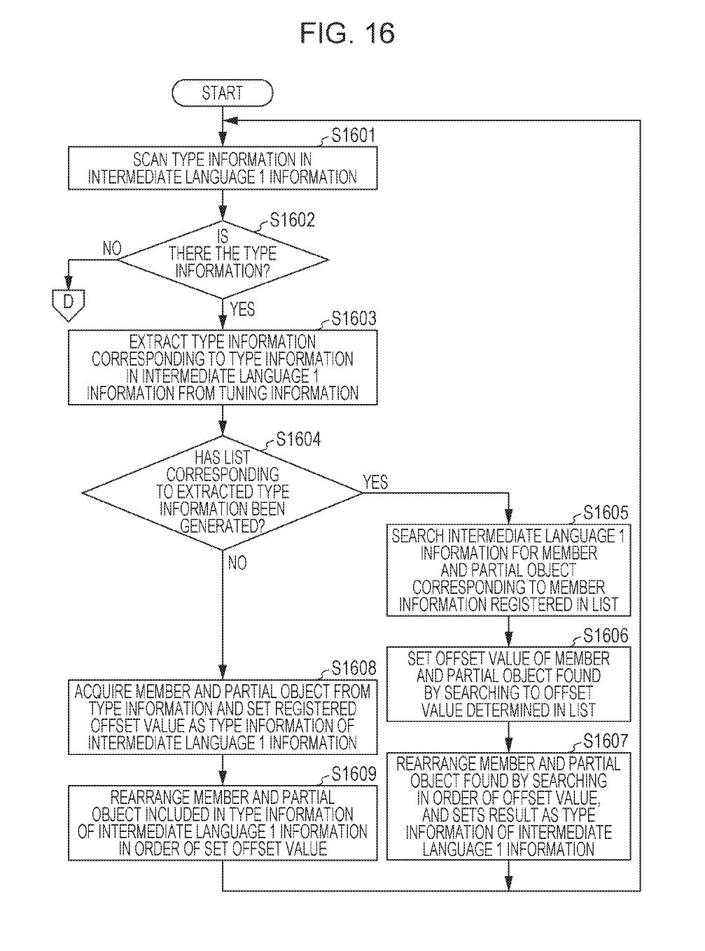

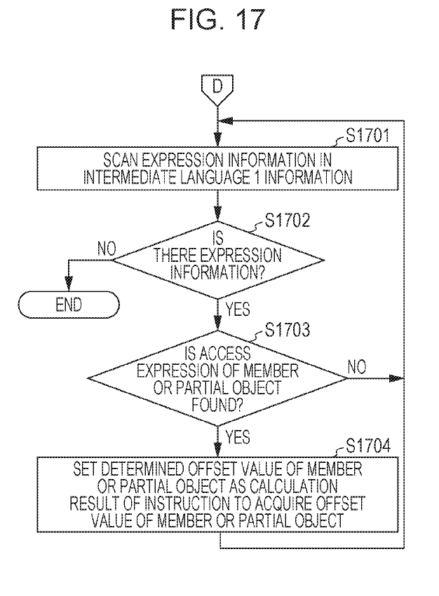

FIG. 16 is a flowchart (part 1) illustrating an example of the member information arrangement position reflection processing procedure. FIG. 17 is a flowchart (part 2) illustrating the example of the member information arrangement position reflection processing procedure. The member information arrangement position reflection processing is processing that reflects the determined offset value to the tuning-executed intermediate language 1 information 323. Here, in the member information arrangement position reflection processing, the tuning-executed intermediate language 1 information 323 is generated by updating the intermediate language 1 information 321.

The computer 101 scans the type information in the intermediate language 1 information 321 (STEP S1601). As a result of scanning, the computer 101 determines whether or not there is the type information (STEP S1602). In a case where there is the type information (Yes in STEP S1602), the computer 101 extracts the type information corresponding to the type information in the intermediate language 1 information 321 from the tuning information 322 (STEP S1603). Then, the computer 101 determines whether or not the list corresponding to the extracted type information has been generated (STEP S1604).

In a case where the list corresponding to the extracted type information has been generated (Yes in STEP S1604), the computer 101 searches the intermediate language 1 information 321 for the member and the partial object corresponding to the member information registered in the list (STEP S1605). Then, the computer 101 sets the offset value of the member and the partial object found by searching as the offset value determined in the list (STEP S1606). Next, the computer 101 rearranges the member and the partial object found by searching in the order of the offset value, and sets the result as the type information of the intermediate language 1 information 321 (STEP S1607). Here, the computer 101 registers the member and the partial object which are originally set in the type information of the intermediate language 1 information 321 so as to continue to the rearranged member and the partial object, and then, updates the offset value. In addition, in the intermediate language 1 information 321, the computer 101 removes the position where the rearranged member and the partial object originally existed. After ending the processing in STEP S1607, the computer 101 moves the process to STEP S1601.

The processing in STEP S1607 will be described using the specific example. The computer 101 sets the offset value of the partial object subobj_C4_C3 to be zero and the offset value of the member mem42 to be 16 as set with regard to the type information of the class C4 which is the type information 504 in the intermediate language 1 information 321 and determined in the list. Then, the computer 101 sets the offset value of the partial objectsubobj_C4_C2 to be 20, and sets the offset value of the member 41 to be 28 so as to continue to the member mem42.

On the other hand, in a case where the list corresponding to the extracted type information has not been generated (No in STEP S1604), the computer 101 acquires the member and the partial object from the type information of the tuning information 322, and sets the registered offset value as the type information of the intermediate language 1 information 321 (STEP S1608). Next, the computer 101 rearranges the member and the partial object included in the type information of the intermediate language 1 information in the order of the set offset value (STEP S1609). After ending the processing in STEP S1609, the computer 101 moves the process to STEP S1601.

As a result of scanning, in a case where there is no type information (No in STEP S1602), the computer 101 scans the expression information in the intermediate language 1 information (STEP S1701). As a result of scanning, the computer 101 determines whether or not there is expression information (STEP S1702). In a case where there is the expression information (Yes in STEP S1702), the computer 101 determines whether or not the access expression of the member or the partial object is found (STEP S1703). In a case where the access expression of the member or the partial object is found (Yes in STEP S1703), the computer 101 sets the determined offset value of the member or the partial object as the calculation result of the instruction to acquire the offset value of the member or the partial object (STEP S1704). Here, if the instruction to acquire the offset value of the member or the partial object has already been calculated, the computer 101 performs the calculation again.

The processing in STEP S1703 and STEP S1704 will be described using the specific example. In STEP S1703, the computer 101 finds the expression information 705 as the access expression of the member or the partial object. Then, in STEP S1704, the computer 101 sets the calculation result of the instruction to acquire the offset value of the member mem12 to be zero.

After ending the processing in STEP S1704 or in a case where the access expression of the member or the partial object is not found (No in STEP S1703), the computer 101 moves the process to STEP S1701. On the other hand, in a case where there is no expression information (No in STEP S1702), the computer 101 ends the member information arrangement position reflection processing. By executing the member information arrangement position reflection processing, the computer 101 can generate the intermediate language 1 information 321 in which the content of the tuning information 322 is reflected.

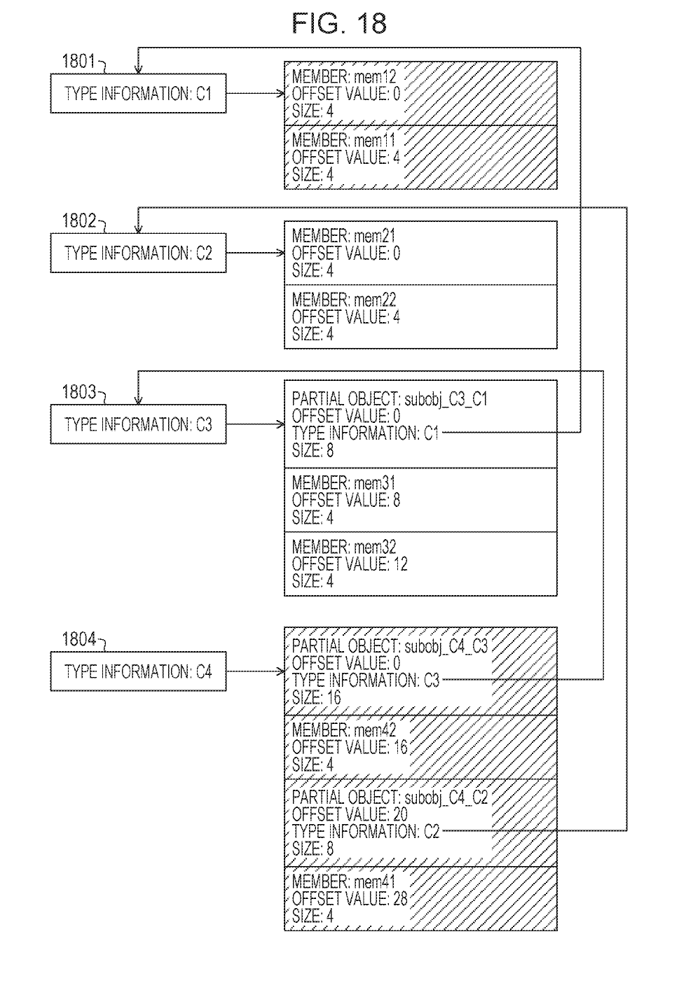

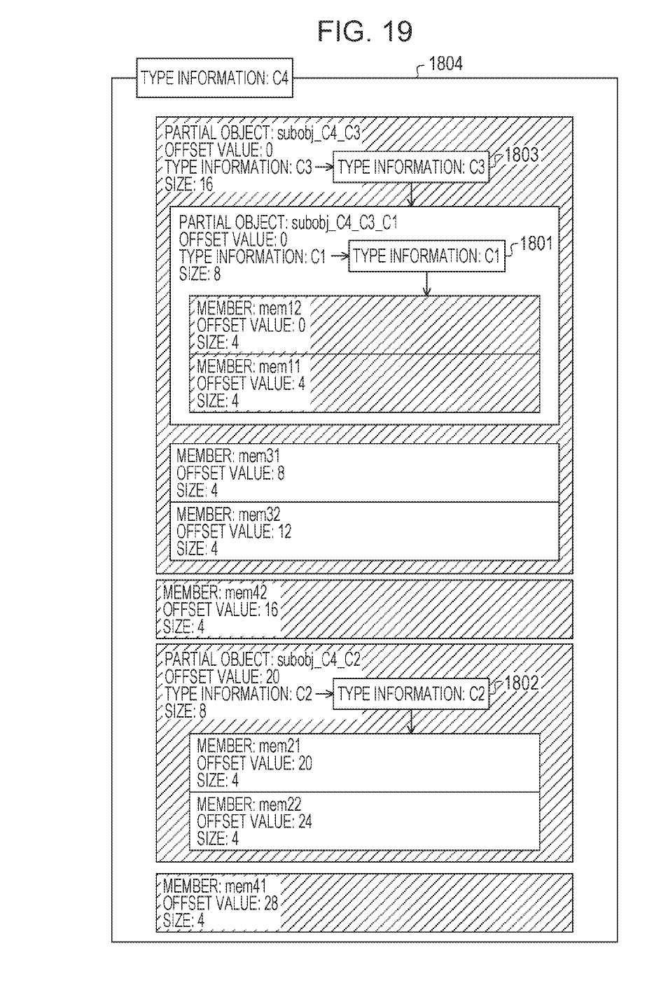

Next, the type information and the data structure of the intermediate language 1 information 323 after the source tuning is performed will be described using FIG. 18 and FIG. 19.

FIG. 18 is an explanatory diagram illustrating an example of expression information of the intermediate language 1 information 323 after the source tuning. In FIG. 18, the type information items 1801 to 1804 of the intermediate language 1 information 323 on which the source tuning is performed are illustrated. The hatched region in FIG. 18 indicates the position changed from the type information items 501 to 504 illustrated in FIG. 5.

Specifically, in the type information of the class C1 which becomes the type information 1801, the order of the members mem11 and mem12 is changed from that in the type information of the class C1 which becomes the type information 501, and the offset values of the members mem11 and mem12 are changed. The type information of the class C2 which becomes the type information 1802 is the same as the type information of the class C2 which becomes the type information 502. In addition, type information of the class C3 which becomes the type information 1803 is the same as the type information of the class C3 which becomes the type information 503.

In the type information of the class C4 which becomes the type information 1804, the order is changed to the order of partial object subobj_C4_C3, the member mem42, the partial object subobj_C4_C2, and the member mem41 from that in the type information of the class C4 which becomes the type information 504. Furthermore, in the type information of the class C4 which becomes the type information 1804, the offset values of the partial object subobj_C4_C3, the member mem42, the partial object subobj_C4_C2, and the member mem41 are changed.

FIG. 19 is an explanatory diagram illustrating an example of a data structure after the source tuning. In FIG. 19, the data structure of the c4obj in the get_subobj( ) function illustrated in FIG. 4 when in accordance with the type information of the class C4 illustrated in FIG. 18, is illustrated.

The data structure of the c4obj is a structure in which the partial objectsubobj_C4_C3, the member mem42, the partial object subobj_C4_C2, and the member mem41 are arranged in the storage region in order in accordance with the type information of the class C4 which becomes the type information 1804.

In addition, the data structure of the partial object subobj_C4_C3 is a structure in which the partial objectsubobj_C4_C3_C1, member mem31, and member mem32 are arranged in the storage region in order in accordance with the type information of the class C3 which becomes the type information 1803. Furthermore, the data structure of the partial object subobj_C4_C3_C1 is a structure in which the member mem12 and the member mem11 are arranged in the storage region in order in accordance with the type information of the class C1 which becomes the type information 1801.

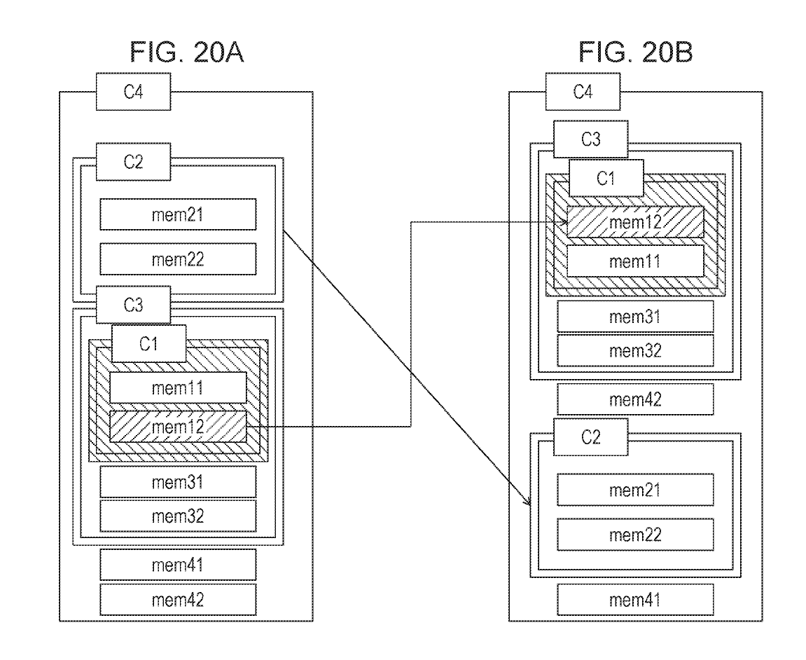

In addition, the data structure of the partial objectsubobj_C4_C2 is a structure in which the member mem21 and the member mem22 are arranged in the storage region in order in accordance with the type information of the class C2 which becomes the type information 1802. Next, the data structure before and after the source tuning will be described using FIG. 20A and FIG. 20B.

FIG. 20A and FIG. 20B are explanatory diagrams illustrating a result of a change of the data structure. FIG. 20A illustrates the data structure of the c4obj illustrated in FIG. 6 and FIG. 20B illustrates the data structure of the c4obj illustrated in FIG. 19. Here, in FIG. 20A and FIG. 20B, the frameworks of the double lines indicate the partial objects.

As illustrated in FIG. 20A and FIG. 20B, the computer 101 rearranges the partial objects in the unit of not only the partial object of the class C1 hatched in the left direction but also in the unit of the partial object of the class C3 which includes the partial object of the class C1 as the member. In addition, with regard to the partial object of the class C2 in which there is no access, the computer 101 changes the order of the partial object of the class C3 and the partial object of the class C2. As a result of the change, the partial object of the class C2 moves to the lower side among the objects of the class C4.

As illustrated in FIG. 20A and FIG. 20B, the computer 101 can make the class C1 having the large number of access times be easily stored in the cache memory. Furthermore, by moving the partial object in the unit of the partial object of the class C3 which includes the partial object of the class C1 as the member, the computer 101 can cope with the expression that collectively processes the partial object of the class C3.

As described above, at the time of compiling, the computer 101 determines the arrangement order of each member and the partial object based on each value obtained by adding the number of access times of the member or the partial object in the partial object to the number of access times of the partial object in the object. In this way, the computer 101 can arrange the member and the partial object based on the number of access times while considering the nested class, and thus, it is possible to improve the access performance of the object program. In addition, since the computer 101 changes the arrangement while considering the nested class, even when there is an expression that collectively processes the partial object which is outside of the nested class, the accurate operation can be performed.

In addition, the computer 101 may determine the offset values of each member and the partial object based on the arrangement order of each determined member and the partial object and the size of each member and the partial object. In this way, the computer 101 can obtain the arrangement position of each member and the partial object in the target storage region.

In addition, the computer 101 may set the offset value of the determined member and the partial object as the calculation result of the instruction to acquire the offset value of the member and the partial object included in the source program 111. In this way, the generated object program 325 can accurately operate the instruction to acquire the offset values of the member and the partial object even after the member and the partial object are rearranged.

In addition, with regard to the member or the partial object having the same number of access times, the computer 101 may determine the order of the member or the partial object in ascending order of the size of the member and the partial object. In this way, the member or the partial object having the small size is stored in the target cache memory with priority. Therefore, more of the members or the partial objects can be stored in the target cache memory compared to the case where the member or the partial object having the large size is stored in the target cache memory with priority, and thus, it is possible to improve the access performance.

In addition, the present embodiment can be applied to a case where the programming language is C language. In this case, by making the object be the class, and by adding the number of access times of the data included in another class to the number of access times to another class itself included in a certain class, and then, the order of the elements included in the certain class can be determined based on the addition resulting value.

The compiling method described in the present embodiment can be realized by a program prepared in advance and is executed by a computer such as a personal computer or a workstation. The present compiler program is stored in a computer-readable recording medium such as a hard disk, a flexible disk, a compact disc-read only memory (CD-ROM), and a digital versatile disk (DVD), and is executed after being read out from the recording medium by the computer. In addition, the present compiler program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer that performs compiling, comprising:
a storage unit for storing a source program, and
a processor configured to execute a process, the process comprising,
adding the number of access times to each of a plurality of data items included in an object specified in the source program counted based on the source program to the number of access times to each of one or more data items included in each of the plurality of data items based on the source program, and
determining an order of each of the plurality of data items when compiling the source program and arranging the compiled program in a storage region based on the number of access times to each data resulting from the adding.

2. The computer that performs compiling according to claim 1,
in the determining, an offset value of each of the plurality of data items from the head address of the object is determined when arranging the data in the storage region based on the determined order and size of each of the plurality of data items.

3. The computer that performs compiling according to claim 2,
wherein the determined offset value of each of the plurality of data items is set as a calculation result of an instruction, included in the source program, to acquire the offset value of each data item.

4. The computer that performs compiling according to claim 1,
wherein, with regard to each data item having the same number of access times, an ascending order of the size of each data item is determined as the order of arrangement in the storage region for each data.

5. A compiling method to be executed by a computer, including steps of;
adding, by the computer, the number of access times to each of a plurality of data items included in an object specified in a source program counted based on the source program to the number of access times to each of one or more data items included in each of the plurality of data items based on the source program, and
determining, by the computer, an order of each of the plurality of data items when compiling the source program and arranging the compiled program in a storage region based on the addition resulting number of access times to each of the plurality of data items.

6. A non-transitory storage medium configured to store a compiler program which causes a computer to execute processing that adds the number of access times to each of a plurality of data items included in an object specified in a source program counted based on the source program to the number of access times to each of one or more data items included in each of the plurality of data items based on the source program, and
determines an order of each of the plurality of data items when compiling the source program and arranging the compiled program in a storage region based on the addition resulting number of access times to each of the plurality of data items.
